(19) United States
(12) Patent Application Publication
(10) Pub. No.: US 2021/0391804 A1
(43) Pub. Date: Dec. 16, 2021

(54) SELF BIASED RECTIFIER CIRCUIT

(71) Applicant: KING ABDULLAH UNIVERSITY OF SCIENCE AND TECHNOLOGY, Thuwal (SA)

(72) Inventors: Khaled Nabil SALAMA, Thuwal (SA); Abdullah Saud ALMANSOURI, Thuwal (SA)

(21) Appl. No.: 17/282,311

(22) PCT Filed: Oct. 1, 2019
(86) PCT No.: PCT/IB2019/058351

§ 371 Date: Apr. 1, 2021

Related U.S. Application Data
(60) Provisional application No. 62/740,006, filed on Oct. 2, 2018.

(51) Int. Cl. H02M 7/217; H02M 1/08

(52) U.S. Cl. CPC H02M 7/217; H02M 1/08

(57) ABSTRACT

A self-biased rectifier circuit includes first and second input terminals and first and second output terminals. The self-biased rectifier circuit also includes a rectifier having first, second, third, and fourth transistors, each having a source, gate, and drain. The sources of the first and second transistors and the gates of the third and fourth transistors are coupled to the first input terminal. The sources of the third and fourth transistors and the gates of the first and second transistors are coupled to the second input terminal. The drains of the first and third transistors are coupled to the second output terminal. The drains of the second and fourth transistors are coupled to the first output terminal. A feedback circuit includes a plurality of transistors configured as at least one rectifier. The feedback circuit is coupled to the gates of the first and third transistors and the plurality of transistors are configured to provide a first biasing voltage or a second biasing voltage to the gates of the first and third transistors depending upon a magnitude of power or voltage applied to the first and second input terminals. Additionally, or alternatively, the feedback circuit is coupled to the gates of the second and fourth transistors and the plurality of transistors are configured to provide a first biasing voltage or a second biasing voltage to the gates of the second and fourth transistors depending upon a magnitude of power or voltage applied to the first and second input terminals.

### CROSS-REFERENCE TO RELATED APPLICATIONS

This application claims priority to U.S. Provisional Patent Application No. 62/740,006, filed on Oct. 2, 2018, entitled “DUAL-MODE RF-TO-DC RECTIFIER,” the disclosure of which is incorporated herein by reference in its entirety.

### BACKGROUND

### Technical Field

Embodiments of the subject matter disclosed herein generally relate to a self-biased rectifier circuit that includes a rectifier and a feedback circuit that adjusts the voltages provided to some or all of the gates of the rectifier depending upon a magnitude of power and/or voltage applied to input terminals of the self-biased rectifier circuit.

### Discussion of the Background

Although there has been an explosion of wireless devices, such as wireless communication devices, these devices are typically charged using a hard-wired connection to a power outlet. In order to achieve more flexibility for charging devices, there has been significant interest in wireless power transfer receivers, an example of which is illustrated in FIG. 1. A wireless power transfer receiver typically includes an antenna 110 to receive radio frequency signals 105 (either ambient or radio frequency signals transmitted towards the receiver), which are alternating current (AC) signals 115. The receivers also include an impedance matching network 120, which provides the received radio frequency signals 105 to an AC/DC converter 125 (also commonly referred to as a rectifier). The AC/DC converter 125 converts the received AC signals 115 into DC signals 130, the corresponding power of which can then be stored in a storage device 135 (e.g., a battery) or can be used to charge a load 140 (e.g., an electronic device).

The efficiency of a wireless power receiver is largely dependent upon the efficiency of the AC/DC converter 125. FIG. 2A illustrates a rectifier commonly referred to as a fully cross-coupled (FX) rectifier. The rectifier includes two NMOS transistors M1 and M3 and two PMOS transistors M2 and M4. As will be recognized by those skilled in the art, the PMOS transistors require a negative voltage or low voltage at the gate to turn ON, while the NMOS transistors require a positive voltage or high voltage at the gate to turn ON. Further, the gate-source voltage of the NMOS transistors needs to be greater than the threshold voltage (Vth) in order for the transistor to turn ON. Also, the source-gate voltage of the PMOS transistors needs to be greater than the absolute threshold voltage (Vth) in order for the transistor to turn on. Moreover, all of these transistors are bi-directional devices, meaning, a gate-drain voltage for NMOS transistors or drain-gate voltage for PMOS transistors greater than the absolute threshold voltage (Vth) of these transistors turn them ON. The RF voltage (V_{RF}) is applied differentially across the rectifier (i.e., +V_{RF}/2 is applied at one input terminal and −VRF/2 is applied at the other input terminal).

When the rectifier is operating in the positive half cycle (i.e., V_{RF}/2>|Vth|): transistor M2 turns ON and the current flows from the input terminal V_{RF}/2, through the transistor M2, and into the VDD output terminal. This makes the voltage at the output terminal VDD more positive. Furthermore, transistor M3 turns ON and the current flows from the output terminal Vss through the transistor M3 and out of the second input terminal −V_{RF}/2. This makes the voltage at the Vss output terminal more negative, and thus the load CL starts charging. During the positive half cycle, transistors M1 and M4 remain OFF.

When the rectifier is operating in the negative half cycle (i.e., V_{RF}/2<−1x |Vth|) transistor M4 turns ON so that the current flows from the input terminal −V_{RF}/2, through the transistor M4, and into the VDD output terminal. This makes the voltage at the VDD output terminal more positive. Furthermore, transistor M1 turns ON so that the current flows from the Vss output terminal, through the transistor M1, to the input terminal V_{RF}/2. This makes the voltage at the output terminal V_{SS} more negative. During the negative half cycle, transistors M2 and M3 remain OFF. In other words, transistors M2 and M4 charge the output terminal V_{DD} by making it more positive, and transistors M1 and M3 charge the output terminal V_{SS} by making it more negative.

One problem with the FX rectifier illustrated in FIG. 2A is that, due to the bi-directionality of the MOSFETs M1-M4, when the accumulated output DC voltage becomes larger than the instantaneous radio frequency input voltage, reverse current (I_{RVS}) flows back towards the input terminals (a phenomenon commonly referred to as reverse current leakage), which results in poor performance when there is high radio frequency input power, and also a poor dynamic range of input powers. Reverse current leakage occurs because the transistors are bi-directional devices so that when the transistor is ON, the current flows from the higher potential to the lower potential, and thus the current can flow from the drain to the source or from the source to the drain. Specifically, in the FX rectifier of FIG. 2A, reverse current leakage occurs when the instantaneous voltage VDD>V_{RF}/2 and the transistor is ON (i.e., VDD+V_{RF}/2 >|Vth|) so that the leakage current flow from the load back to the input of the FX rectifier.

One solution to address these problems with FX rectifiers is to employ a self-biased rectifier, an example of which is illustrated in FIG. 2B. This rectifier is a modification of the FX rectifier of FIG. 2A by including two feedback resistors, RFB1 and RFB2. These resistors lower the reverse current flowing in transistors M2 and M4 by increasing the DC voltage at the gate of these transistors. The increased DC voltage at the gates of transistors M2 and M4 lowers both the forward and the reverse leakage current. In the self-biased rectifier of FIG. 2B, the reverse current leakage current occurs when VDD>V_{RF}/2 and transistors M2 and M4 are ON (V_{RF}/2 >|Vth|). In this arrangement, a higher VRF voltage is required to turn ON transistors M2 and M4, which beneficially reduces the reverse leakage current. This self-biased rectifier exhibits improved performance at high radio frequency power and an improved dynamic range compared to the FX rectifier of FIG. 2A.

Because the resistors RFB1 and RFB2 limit the forward current (I_{FWD}), in addition to lowering the reverse current (I_{RVS}), there is a drop in the peak power conversion efficiency (PCE) and the self-biased rectifier exhibits poor performance at low radio frequency power. Furthermore, the feedback resistors RFB1 and RFB2 consume a large amount of area and introduce a significant amount of parasitics, which is problematic in a radio frequency application. Moreover, the self-biased rectifier becomes highly sensitive to the loading value—for example, the peak power conversion efficiency drops by approximately 27% when the load varies from 50 to 200 kΩ.

Thus, there is a need for a rectifier circuit that operates efficient by maintaining a higher power conversion efficiency at low, medium, and high input radio frequency power.

### SUMMARY

According to an embodiment, there is a self-biased rectifier circuit, which includes first and second input terminals and first and second output terminals. The self-biased rectifier circuit also includes a rectifier having first, second, third, and fourth transistors, each having a source, gate, and drain. The sources of the first and second transistors and the gates of the third and fourth transistors are coupled to the first input terminal. The sources of the third and fourth transistors and the gates of the first and second transistors are coupled to the second input terminal. The drains of the first and third transistors are coupled to the second output terminal. The drains of the second and fourth transistors are coupled to the first output terminal. A feedback circuit includes a plurality of transistors configured as at least one rectifier. The feedback circuit is coupled to the gates of the first and third transistors and the plurality of transistors are configured to provide a first biasing voltage or a second biasing voltage to the gates of the first and third transistors depending upon a magnitude of power or voltage applied to the first and second input terminals. Additionally, or alternatively, the feedback circuit is coupled to the gates of the second and fourth transistors and the plurality of transistors are configured to provide a first biasing voltage or a second biasing voltage to the gates of the second and fourth transistors depending upon a magnitude of power or voltage applied to the first and second input terminals.

According to another embodiment, there is a method for converting an alternating current signal into a direct current signal. The alternating current signal is received by a self-biased rectifier circuit that includes first and second input terminals and first and second output terminals. The self-biased rectifier circuit converts the alternating current signal into a direct current signal. The self-biased rectifier circuit includes first, second, third, and fourth transistors arranged as fully cross-coupled rectifier. The conversion of the alternating current signal into a direct current signal involves providing, by a feedback circuit coupled to the gates of the first and third transistors, a voltage obtained from the first and the second input terminals to the gates of the first and third transistors depending upon a magnitude of power or voltage applied to the first and second input terminals. Alternatively, or additionally, the conversion of the alternating current signal into a direct current signal involves providing, by a feedback circuit coupled to the gates of the second and fourth transistors, a voltage obtained from the first and the second input terminals to the gates of the second and fourth transistors depending upon a magnitude of power or voltage applied to the first and second input terminals.

According to another embodiment, there is a wireless power receiver, which includes an antenna configured to receive a wireless alternating current signal. An impedance matching network is coupled to the antenna to receive the alternating current signal. A self-biased rectifier circuit is coupled to the impedance matching network and configured to convert the alternating current signal into a direct current signal. The self-biased rectifier circuit includes first and second input terminals coupled to the impedance matching network, first and second output terminals, and a rectifier comprising first, second, third, and fourth transistors, each comprising a source, gate, and drain. The sources of the first and second transistors and the gates of the third and fourth transistors are coupled to the first input terminal. The sources of the third and fourth transistors and the gates of the first and second transistors are coupled to the second input terminal. The drains of the first and third transistors are coupled to the second output terminal. The drains of the second and fourth transistors are coupled to the first output terminal. The self-biased rectifier circuit also includes a feedback circuit comprising a plurality of transistors configured as at least one rectifier. The feedback circuit is coupled to the gates of the first and third transistors and the plurality of transistors are configured to provide a first biasing voltage or a second biasing voltage to the gates of the first and third transistors depending upon a magnitude of power or voltage applied to the first and second input terminals. Alternatively, or additionally, the feedback circuit is coupled to the gates of the second and fourth transistors and the plurality of transistors are configured to provide a first biasing voltage or a second biasing voltage to the gates of the second and fourth transistors depending upon a magnitude of power or voltage applied to the first and second input terminals.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a wireless power receiver;

FIGS. 2A and 2B are schematic diagrams of conventional rectifier circuits for use in a wireless power receiver;

FIGS. 3A-3E are schematic diagrams of self-biased rectifier circuits according to embodiments;

FIGS. 4A-4F are schematic diagrams of feedback circuits according to embodiments;

FIGS. 5A is a schematic diagram of a self-biased rectifier circuit according to embodiments;

FIGS. 5B and 5C are schematic diagrams of the feedback circuit of the self-biased rectifier circuit of FIG. 5A at low input power and at high input power, respectively;

FIG. 6 is a graph comparing the power conversion efficiency of the self-biased rectifier circuit of FIG. 5A with conventional rectifier circuits; and

FIG. 7 is a flowchart of a method for converting an alternating current signal into a direct current signal using a self-biased rectifier circuit according to embodiments.

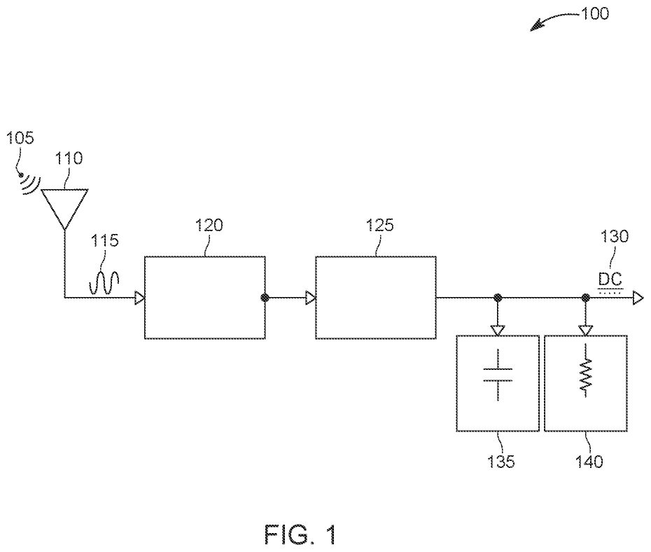

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a rectifier.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

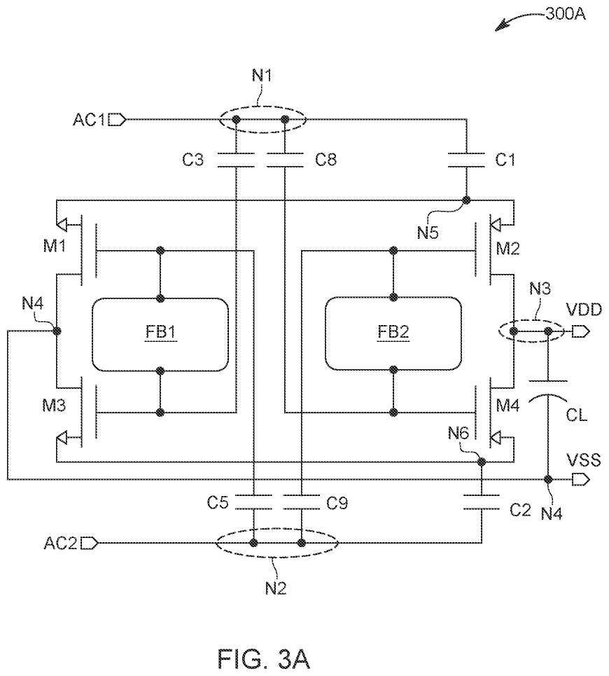

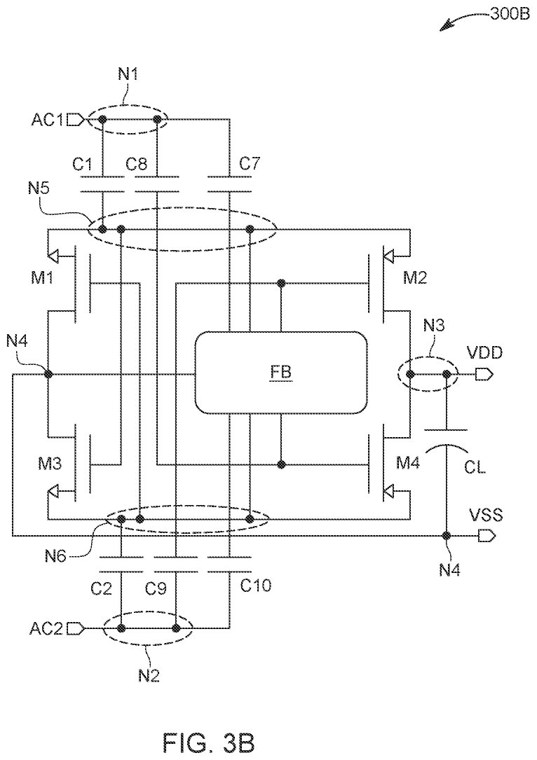

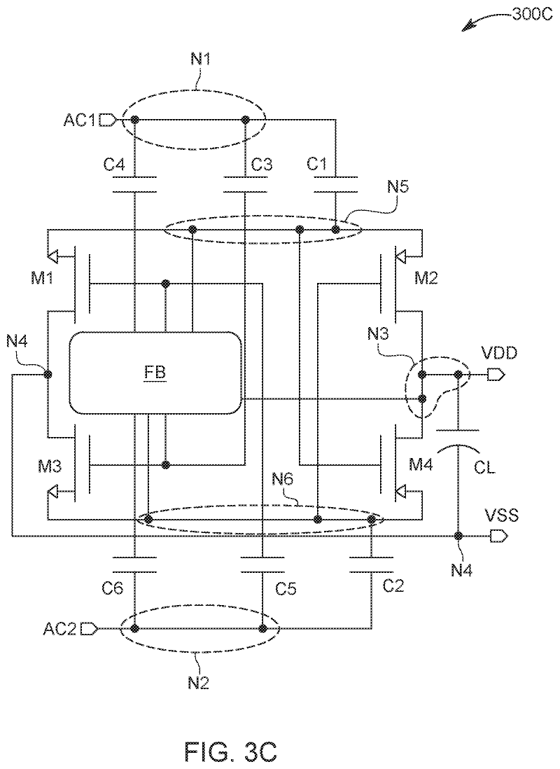

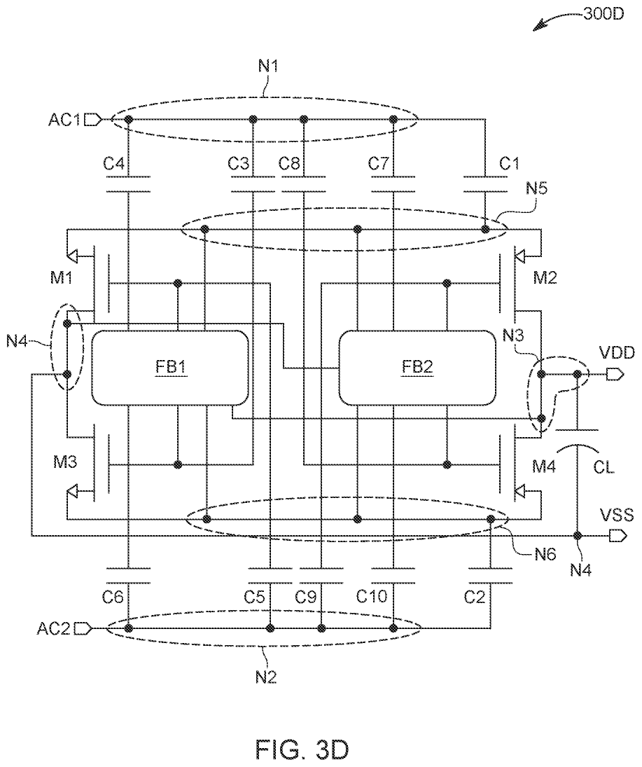

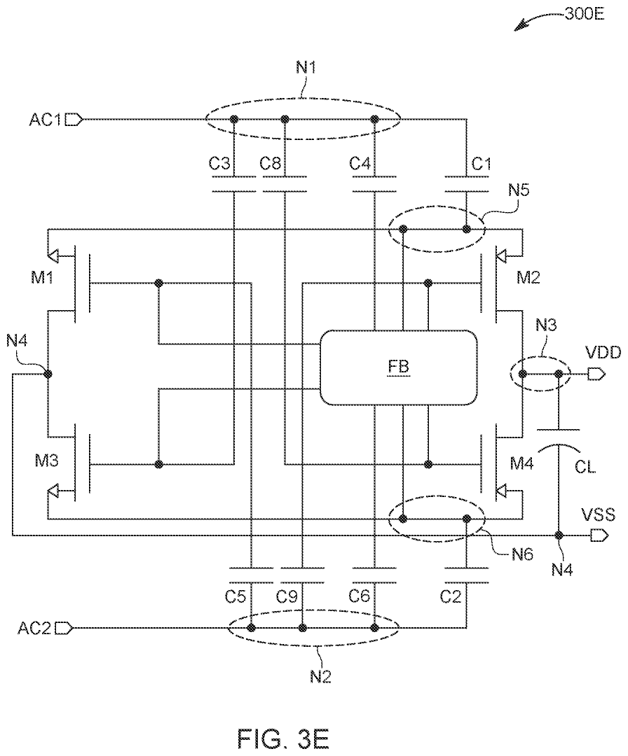

FIGS. 3A-3E illustrate self-biased rectifier circuits 300A-300E, the common features of which will be described first and the differences between the circuits will follow. Specifically, FIG. 3A illustrates a generic self-biased rectifier circuit 300A, which can have one or both of feedback circuits FB1 and FB2, while FIGS. 3B-3E are specific implementations of the generic self-biased rectifier circuit 300A.

The self-biased rectifier circuits 300A-300E include first AC1 and second AC2 input terminals and first VDD and second VSS output terminals. The self-biased rectifier circuits 300A-300E also include a rectifier comprising first M1, second M2, third M3, and fourth M4 transistors, each comprising a source, gate, and drain. The sources of the first M1 and second M2 transistors and the gates of the third M3 and fourth M4 transistors are coupled to the first input terminal AC1. The sources of the third M3 and fourth M4 transistors and the gates of the first M1 and second M2 transistors are coupled to the second input terminal AC2. The drains of the first M1 and third M3 transistors are coupled to the second output terminal VSS. The drains of the second M2 and fourth M4 transistors are coupled to the first output terminal VDD.

The self-biased rectifier circuits 300A-300E also include a feedback circuit FB comprising a plurality of transistors configured as at least one rectifier. In order to provide disclosed gate biasing, in the circuit 300A of FIG. 3A the first feedback circuit FB1 is coupled to the gates of the first M1 and third M3 transistors and the second feedback circuit FB2 is coupled to the gates of the second M2 and fourth M4 transistors (either or both FB1 and FB2 can be employed in the circuit 300A). In the circuit 300B of FIG. 3B the feedback circuit FB is coupled to the gates of the second M2 and the fourth M4 transistors. In the circuit 300C of FIG. 3C the feedback circuit FB is coupled to the gates of the first M1 and third M3 transistors. In the circuit 300D in FIG. 3D the feedback circuit comprises two feedback circuits, a first feedback circuit FB1 is coupled to the gates of the first M1 and third M3 transistors and a second feedback circuit FB2 is coupled to the second M2 and fourth M4 transistors. In the circuit 300E in FIG. 3E the feedback circuit is coupled to the gates of the first M1, second M2, third M3, and fourth M4 transistors. It should be recognized that in the circuits of FIGS. 3A-3E, the capacitor CL connected between the output terminals VDD and VSS is not an actual physical capacitor but instead represents the load (i.e., the device receiving the dc voltage), which alternatively can be a resistive load.

Accordingly, in the circuits of FIGS. 3A, 3C, 3D, and 3E, the feedback circuit FB (or FB1 in FIG. 3A if FB1 is present; or FB1 in FIG. 3D) is coupled to the gates of the first M1 and third M3 transistors and the plurality of transistors of the feedback circuit are configured to provide a biasing voltage obtained from the first terminal AC1 or second terminal AC2 to the gates of the first M1 and third M3 transistors depending upon a magnitude of power or voltage applied to the first AC1 and second AC2 input terminals. Further, in the circuits of FIGS. 3A, 3B, 3D, and 3E, the feedback circuit FB (or FB in FIG. 3A if FB2 is present; or FB2 in FIG. 3D) is coupled to the gates of the second M2 and fourth M4 transistors and the plurality of transistors of the feedback circuit are configured to provide a biasing voltage obtained from the first terminal AC1 or second terminal AC2 to the gates of the second M2 and fourth M4 transistors depending upon a magnitude of the power or voltage applied to the first AC1 and second AC2 input terminals. It should be noted that the Vss and Vdd signals provided by the feedback circuits FB are not necessarily the same as the VSS and VDD signals output from the rectifying transistors M1-M4. Thus, for purposes of the discussion herein the Vdd signals provided by the feedback circuits can be considered as “high” voltage and the Vss signals provided by the feedback circuits can be considered as “low” voltage, the terms high and low voltage being relative to each other.

More specifically, as illustrated in FIGS. 3B-3E, the first input terminal AC1 is coupled to a first node N1 and the second input terminal AC2 is coupled to a second N2 node. The first output terminal VDD and the drains of the second M2 and fourth M4 transistors are coupled to a third node N3. The second output terminal VSS and the drains of the first M1 and third M3 transistors are coupled to a fourth N4 node. The sources of the first M1 and second M2 transistors and the feedback circuit FB (or FB1 and FB2) are coupled to a fifth node N5. A first capacitor C1 is coupled between the fifth node N5 and the first node N1. The sources of the third M3 and fourth M4 transistors and the feedback circuit FB (or FB1 and FB2) are coupled to a sixth node N6. A second capacitor C2 is coupled between the sixth node N6 and the second node N2. FIG. 3A has similar connections and, in any event, the feedback circuits FB1 and FB2 bias the gates of transistors M1 and M3, and of transistors M2 and M4, respectively.

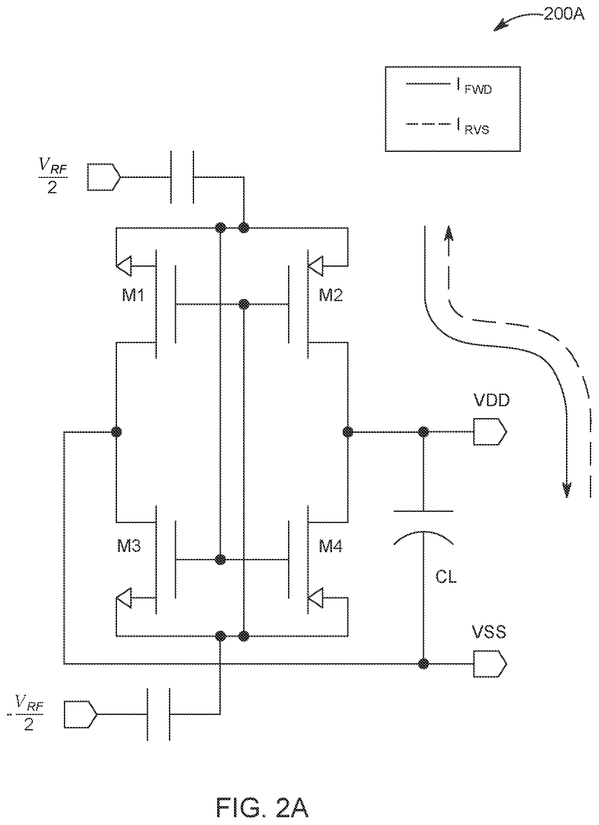

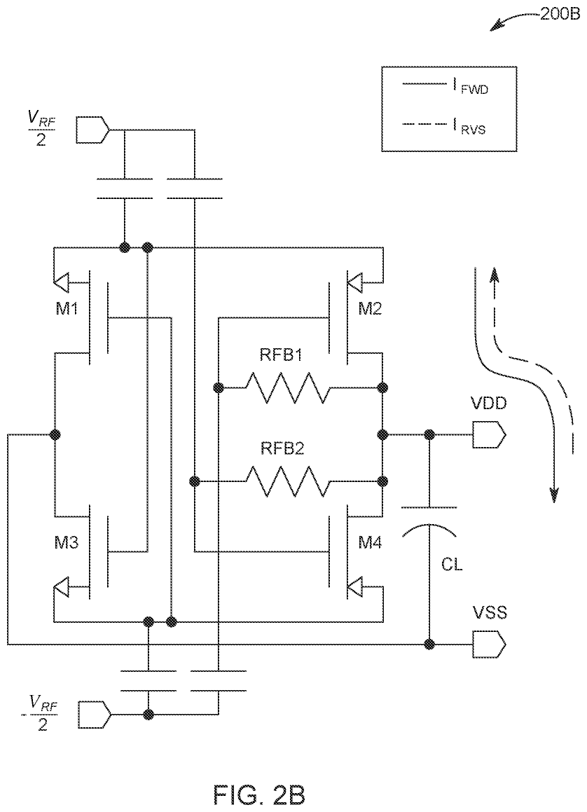

The self-biased rectifier circuits 300A-300E operate in a similar manner to the FX rectifier circuit discussed above in connection with FIG. 2A. The difference being the power- or voltage dependent gate biasing provided by the feedback circuit FB (or feedback circuits FB1 and FB2). Specifically, the poor efficiency of conventional CMOS-based rectifiers at low radio frequency power levels is due to the threshold voltage of the transistors M1-M4, which is typically higher than the corresponding voltage provided at such low radio frequency power levels. Thus, the transistors in conventional CMOS-based rectifiers will not turn ON at such low power levels and efficient rectification is not achieved. The feedback circuit of the self-biased rectifier of FIG. 2B only provides Vdd at the gates of transistors M2 and M4 at both high and low input powers. In contrast, the feedback circuits FB in FIGS. 3A-3E can provide both Vdd and Vss to gates of transistors in the FX rectifier, depending upon the magnitude of the input power or the input voltage.

The feedback circuit FB of the self-biased rectifier circuits 300A-300E address this problem of conventional rectifier circuits by biasing the transistor gates depending upon the input power or the input voltage level. Specifically, in the circuit 300A of FIG. 3A, the feedback circuit FB1 biases the gates of transistors M1 and M3 with Vdd at low input power or low input voltage (which enhances the forward current) and Vss at high input power or high input voltage (which reduces the reverse current leakage) and/or the feedback circuit FB2 biases the gates of transistors M2 and M4 with Vss at low input power or low input voltage (which enhances the forward current) and Vdd at high input power or high input voltage (which reduces the reverse current leakage). In contrast, the rectifier of FIG. 2B provides Vdd at both high and low input power, and providing Vdd at low input power to the gates of transistors M2 and M4 disadvantageously reduces forward current.

In the circuit 300B of FIG. 3B, the feedback circuit FB biases the gates of transistors M2 and M4 with Vss at low input power or low input voltage (which enhances the forward current) and with Vdd at high input power or high input voltage (which reduces the reverse current leakage). In the circuit 300C of FIG. 3C, the feedback circuit FB biases the gates of transistors M1 and M3 with Vdd at low input power or low input voltage (which enhances the forward current) and with Vss at high input power or high input voltage (which reduces the reverse current leakage). In the circuit 300D of FIG. 3D, the feedback circuit FB1 biases the gates of transistors M1 and M3 with Vdd at low input power or low input voltage (which enhances the forward current) and Vss at high input power or high input voltage (which reduces the reverse current leakage) and the feedback circuit FB2 biases the gates of transistors M2 and M4 with Vss at low input power or low input voltage (which enhances the forward current) and Vdd at high input power or high input voltage (which reduces the reverse current leakage). In the circuit 300E of FIG. 3E, at high input power or high input voltage, the feedback circuit FB biases the gates of transistors M1 and M3 with Vss (which reduces the reverse current leakage) and the gates of transistors M2 and M4 with Vdd (which reduces reverse current leakage). Thus, the circuits 300A-300D of FIGS. 3A-3D provide different biases to the transistor gates depending upon whether the input power or input voltage is high or low, whereas the circuit 300E of FIG. 3E only applies a bias to the transistor's gates when the input power or the input voltage is high. Accordingly, the circuit 300E of FIG. 3E only enhances high-power or high-voltage performance because the feedback circuit will not bias the transistor's gates at low input power. Nonetheless, the circuit 300E biases transistor gates depending upon the magnitude of power or voltage applied at the first AC1 and second AC2 input terminals.

Additional details of the different configurations of the circuits of FIGS. 3A-3E will now be addressed. Referring now to FIG. 3A, the feedback circuit comprises one or more feedback circuits FB1 and/or FB2. One of the one or more feedback circuits FB2 is coupled to the gates of the second M2 and fourth M4 transistors. An eighth capacitor C8 is coupled between the first node N1 and the gate of the fourth transistor M4 and a ninth capacitor C9 is coupled between the second node N2 and the gate of the second transistor M2. A second one of the one or more feedback circuits FB1 is coupled to the gates of the first M1 and third M3 transistors. A third capacitor C3 is coupled between the first node N1 and the gate of the third transistor M3 and a fifth capacitor C5 is coupled between the second node N2 and the gate of the first transistor M1. The self-biased rectifier circuit 300A in FIG. 3A can have either or both of the first FB1 and second FB2 feedback circuits.

Referring now to the self-biased rectifier circuit of FIG. 3B, the feedback circuit FB is coupled to the gates of the second M2 and fourth M4 transistors and to the fourth node N4. An eighth capacitor C8 is coupled between the first node Ni and the gate of the fourth transistor M4. A seventh capacitor C7 is coupled between the feedback circuit FB and the first node N1. A ninth capacitor C9 is coupled between the second node N2 and the gate of the second transistor M2. A tenth capacitor C10 is coupled between the second node N2 and the feedback circuit FB.

Turning now to FIG. 3C, the feedback circuit FB is coupled to the gates of the first M1 and third M3 transistors and to the third node N3. A third capacitor C3 is coupled between the first node N1 and the gate of the third transistor M3. A fourth capacitor C4 is coupled between the first node N1 and the feedback circuit. A fifth capacitor C5 is coupled between the second node N2 and the gate of the first transistor M1. A sixth capacitor C6 is coupled between the second node N2 and the feedback circuit.

Referring now to FIG. 3D, the feedback circuit FB comprises first FB1 and second FB2 feedback circuits. The first feedback circuit FB1 is coupled to the gates of the first M1 and third M3 transistors and to the third node N3. The second feedback circuit FB 2 is coupled to the gates of the second M2 and fourth M4 transistors and to the fourth node N4. A third capacitor C3 is coupled between the first node Ni and the gate of the third transistor M3. A fourth capacitor C4 is coupled between the first node N1 and the first feedback circuit FB1. A fifth capacitor C5 is coupled between the second node N2 and the gate of the first transistor M1. A sixth capacitor C6 is coupled between the second node N2 and the first feedback circuit FB1. A seventh capacitor C7 is coupled between the first node N1 and the second feedback circuit FB2. An eighth capacitor C8 is coupled between the first node N1 and the gate of the fourth transistor M4. A ninth capacitor C9 is coupled between the second node N2 and the gate of the second transistor M2. A tenth capacitor C10 is coupled between the second node N2 and the second feedback circuit FB2.

Referring now to FIG. 3E, the feedback circuit FB is coupled to the gates of the first M1, second M2, third M3, and fourth M4 transistors. A third capacitor C3 is coupled between the first node N1 and the gate of the third transistor M3. A fourth capacitor C4 is coupled between the first node N1 and the feedback circuit FB. A fifth capacitor C5 is coupled between the second node N2 and the gate of the first transistor M1. A sixth capacitor C6 is coupled between the second node N2 and the feedback circuit FB. A ninth capacitor C9 is coupled between the second node N2 and the gate of the second transistor M2. An eighth capacitor C8 is coupled between the first node N1 and the gate of the fourth transistor M4.

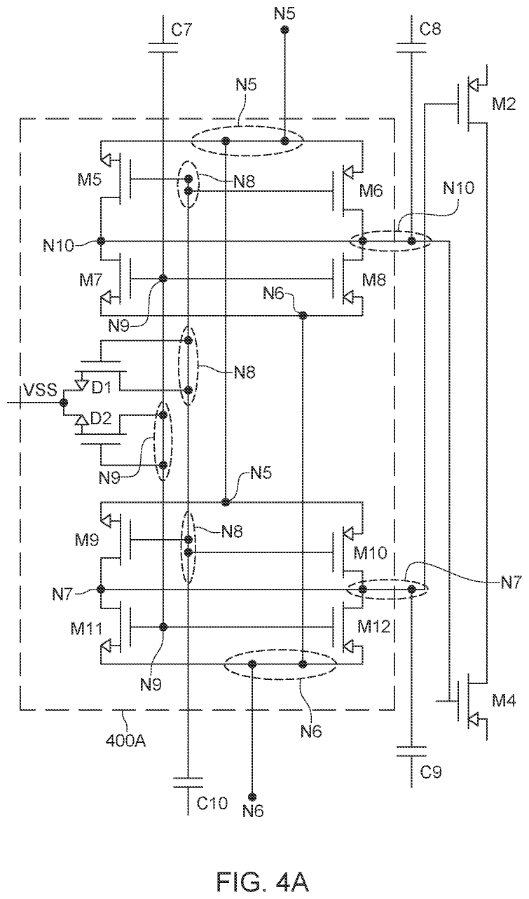

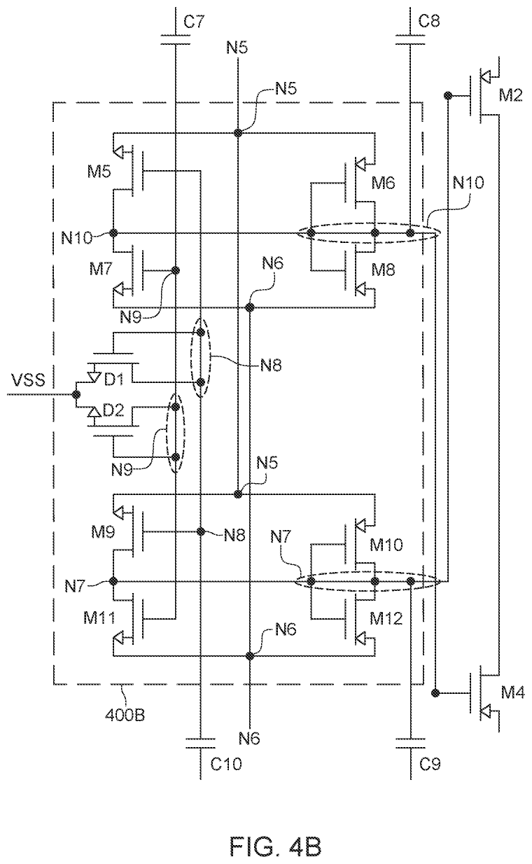

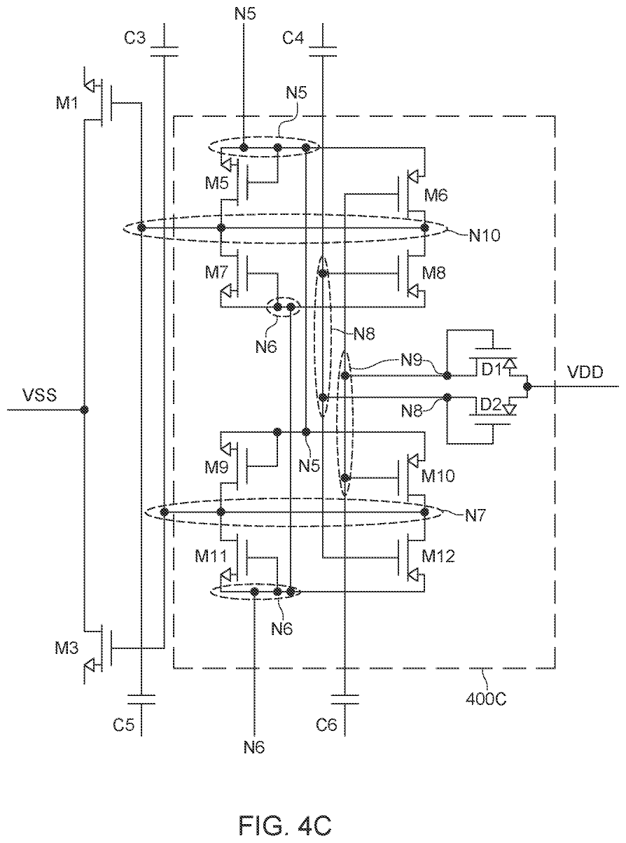

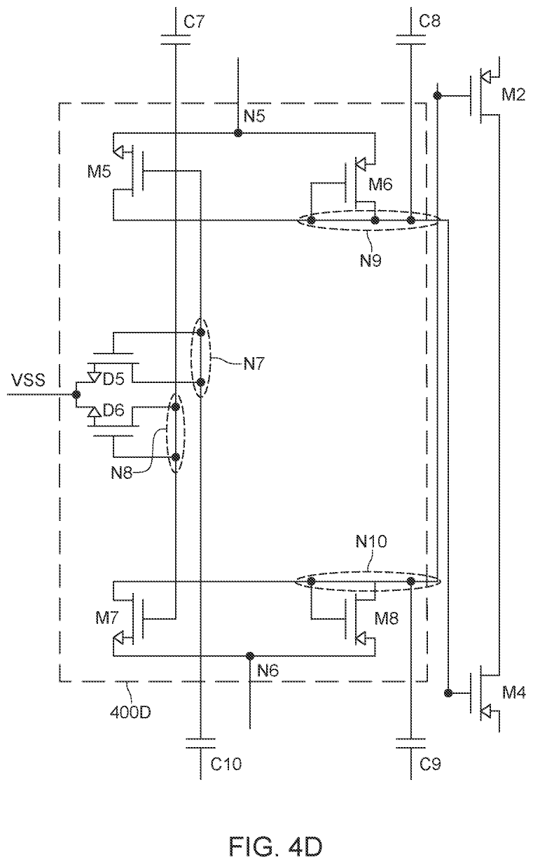

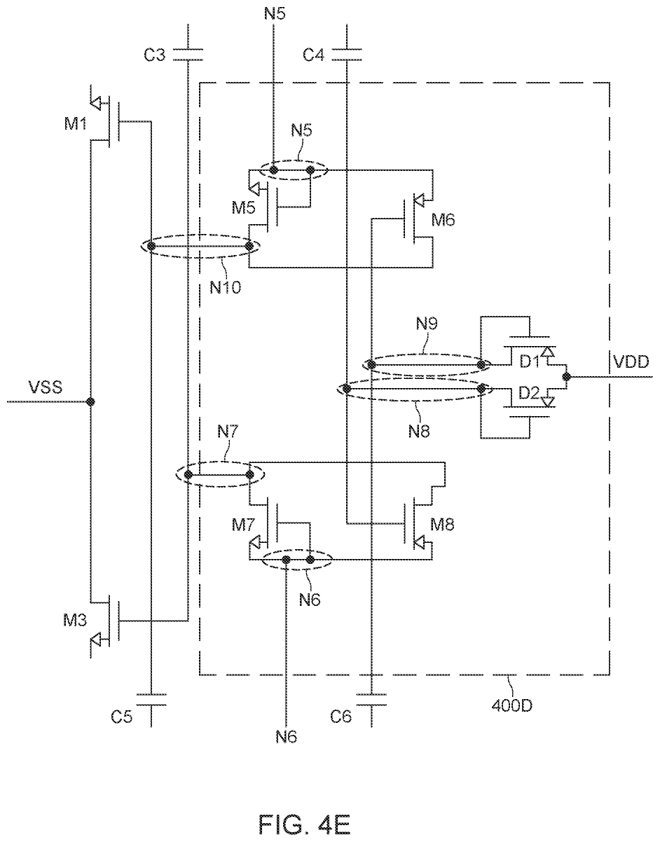

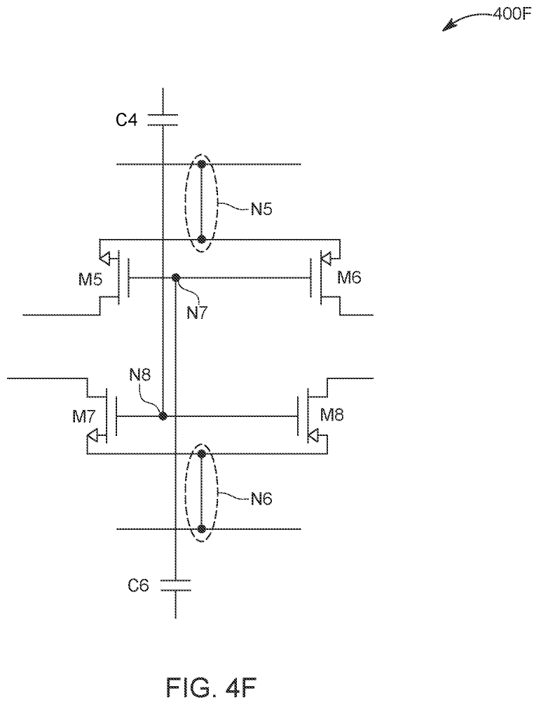

As noted above, in connection with FIGS. 3A-3E, the feedback circuit FB (or FB1 and FB2) include a number of transistors. As will be appreciated from the discussion below in connection with FIGS. 4A-4E, the transistors of the feedback circuits 400A-400E are connected to each other to form at least one rectifier. The feedback circuits illustrated in FIGS. 4A-4E can be used in the self-biased rectifier circuits of FIGS. 3A-3E. Specifically, the feedback circuits of FIGS. 4A-4C can be used in the self-biased rectifier circuits of FIGS. 3A, 3B, and 3D, the feedback circuits of FIGS. 4D and 4E can be used in the self-biased rectifier circuits of FIGS. 3C and 3D, and the feedback circuit of FIG. 4F can be used with the self-biased rectifier circuit of FIG. 3E. These are non-limiting implementations of the feedback circuits and one skilled in the art will recognize that the feedback circuits can have different designs while still achieving the desired gate biasing disclosed herein. The discussion below refers to one or more of the first N1 through sixth N6 nodes, which should be understood as referring to the corresponding first N1 through sixth N6 nodes discussed above in connection with FIGS. 3A-3E. Similarly, in FIGS. 4A-4F, the capacitors C1-C10 correspond to the elements having the same labels in FIGS. 3A-3E. In all of the feedback circuits 400A-400E, the transistors are configured as weak transistors that do not pass significant current in order not to consume or waste significant amounts of the input power (i.e., in order to achieve a higher efficiency of the overall circuit). As will be recognized by those skilled in the art, weak transistors can be achieved by using transistors with small widths and long lengths.

The feedback circuits illustrated in FIGS. 4A-4C comprise fifth M5, sixth M6, seventh M7, eighth M8, ninth M9, tenth M10, eleventh M11, and twelfth M12 transistors, each comprising a source, gate, and drain. The fifth M5, sixth M6, seventh M7, and eighth M8 transistors form a first fully cross-coupled rectifier. The ninth M9, tenth M10, eleventh M11, and twelfth M12 transistors form a second fully cross-coupled rectifier. The sources of the fifth M5, sixth M6, ninth M9, and tenth M10 transistors are coupled to the fifth node N5. The sources of the seventh M7, eighth M8, eleventh M11, and twelfth M12 transistors are coupled to the sixth node N6. In the feedback circuits 400A-4000, the NMOS transistors (i.e., M5, M7, M9, and M11) are low threshold transistors that turn on at lower input power or input voltage to provide the Vss signal at low power or low voltage and the PMOS transistors (i.e., M6, M8, M10, and M12) are high threshold transistors that turn on at high input power or input voltage to provide the Vdd signal at high power or high voltage. The differences between FIGS. 4A-4C are addressed below.

Turning first to FIG. 4A, the gates of the fifth M5, sixth M6, ninth M9, and tenth M10 transistors are coupled to an eighth node N8. The gates of the seventh M7, eighth M8, eleventh M11, and twelfth M12 transistors are coupled to a ninth node N9. The drains of the fifth M5, sixth M6, seventh M7, and eighth M8 transistors and the gate of the fourth transistor M4 are coupled to a tenth node N10. The drains of the ninth M9, tenth M10, eleventh M11, and twelfth M12 transistors and the gate of the second transistor M2 are coupled to a seventh eleventh node N7.

An eighth capacitor C8 is coupled between the first N1 (not illustrated in this figure) and tenth N10 nodes. A seventh capacitor C7 is coupled between the first N1 and ninth N9 nodes. A ninth capacitor C9 is coupled between the second N2 (not illustrated in this figure) and seventh N7 nodes. A tenth capacitor C10 is coupled between the second N2 and eighth N8 nodes. A pair of diode-connected transistors D1 and D2 are coupled to the second output terminal VSS and the eighth N8 and ninth N9.

In the illustrated embodiment, the pair of diode-connected transistors are NMOS transistors, each comprising a source, gate, and drain. The sources of the pair of diode-connected transistors D1 and D2 are coupled to the second output terminal VSS. The gate and drain of a first one D1 of the pair of diode-connected transistors are coupled to the eighth node N8. The gate and drain of a second one D2 of the pair of diode-connected transistors are coupled to the ninth node N9. Transistors D1 and D2 are low threshold diode-connected transistors, which when turned on by input power or input voltage, lowers the conductivity of transistors M5, M7, M9, and M11 to prevent short circuit current in two cases. In the first case, short circuit current is prevented between transistors M6 and M8 and transistors M5 and M7. In the second case, short circuit current is prevented transistors M10 and M12 and transistors M9 and M11.

Although FIG. 4A illustrates the first rectifier coupled to the gate of the fourth transistor M4 and the second rectifier coupled to the gate of the second transistor M2, these connections can be reversed so that the first rectifier is coupled to the gate of the second transistor M2 and the second rectifier is coupled to the gate of the fourth transistor M4. Thus, the feedback circuit 400A generates the Vdd and Vss signals to bias the gates of transistors M2 and M4.

The feedback circuit 400B of FIG. 4B is similar to the feedback circuit 400A of FIG. 4A. The difference is that in the feedback circuit 400B transistors M6, M8, M10, and M12 are diode-connected transistors. This difference between feedback circuits generates the Vdd signal at the gates of transistors M2 and M4 at even higher input power or input voltage in the feedback circuit 400B of FIG. 4B compared to the feedback circuit 400A of FIG. 4A. It will be appreciated that the diode-connected transistors M6, M8, M10, and M12 of feedback circuit 400B turn ON at higher input power or input voltage compared to the corresponding transistors M6, M8, M10, and M12 of feedback circuit 400A.

The gates of the fifth M5 and ninth M9 transistors are coupled to an eighth node N8. The gates of the seventh M7 and eleventh M11 transistors are coupled to a ninth node N9. The drains of the fifth M5, sixth M6, seventh M7, and eighth M8 transistors, the gates of the sixth M6 and eighth M8 transistors, and the gate of the fourth transistor M4 are coupled to a tenth node N10. The drains of the ninth M9, tenth M10, eleventh M11, and twelfth M12 transistors, the gates of the tenth M10 and twelfth M12 transistor, and the gate of the second transistor M2 are coupled to a seventh node N7.

An eighth capacitor C8 is coupled between the first N1 (not illustrated in this figure) and tenth N10 nodes. A seventh capacitor C7 is coupled between the first N1 and ninth N9 nodes. A ninth capacitor C9 is coupled between the second N2 (not illustrated in this figure) and seventh N7 nodes. A tenth capacitor C10 is coupled between the second N2 and eighth N8 nodes. A pair of diode-connected transistors D1 and D2 are coupled to the second output terminal VSS and the eighth N8 and ninth N9 nodes.

In the illustrated embodiment, the pair of diode-connected transistors are NMOS transistors, each comprising a source, gate, and drain. As illustrated, the sources of the pair of diode-connected transistors D1 and D2 are coupled to the second output terminal VSS. The gate and drain of a first one D1 of the pair of diode-connected transistors are coupled to the eighth node N8. The gate and drain of a second one D2 of the pair of diode-connected transistors are coupled to the ninth node N9. These diode-connected transistors D1 and D2 in the feedback circuit 400B operate similarly to those in feedback circuit 400A to prevent the short circuit current as discussed above. It should be recognized that if PMOS transistors are employed for the pair of diode-connected transistors, then the gate would be connected to the fourth node N4 (not shown in this Figure).

Turning now to FIG. 4C, the gates of the fifth M5 and ninth M9 transistors are coupled to the fifth node N5. The gates of the seventh M7 and eleventh M11 transistors are coupled to the sixth node N6. The gates of the eighth M8 and twelfth M12 transistors are coupled to an eighth node N8. The gates of the sixth M6 and tenth M10 transistors are coupled a ninth node N9. The drains of the fifth M5, sixth M6, seventh M7, and eighth M8 transistors, and the gate of the first transistor M1 are coupled to a tenth node N10. The drains of the ninth M9, tenth M10, eleventh M11, and twelfth M12 transistors, and the gate of the third transistor M3 are coupled to a seventh node N7. A third capacitor C3 is coupled between the first N1 and seventh nodes N7. A fourth capacitor C4 is coupled between the first N1 and eighth N8 nodes. A fifth capacitor C5 is coupled between the second N2 and tenth N10 nodes. A sixth capacitor is coupled between the second N2 and ninth N9 nodes. A pair of diode-connected transistors D1 and D2 are coupled to the first output terminal VDD and the eighth N8 and ninth N9 nodes.

In the illustrated embodiment, the pair of diode-connected transistors D1 and D2 are PMOS transistors, each comprising a source, gate, and drain. As illustrated, the sources of the pair of diode-connected transistors D1 and D2 are coupled to the first output terminal VDD. The gate and drain of a first one D1 of the pair of diode-connected transistors are coupled to the ninth node N9. The gate and drain of a second one D2 of the pair of diode-connected transistors are coupled to the eighth node N8. These diode-connected transistors D1 and D2 in the feedback circuit 400C operate similarly to those in feedback circuit 400A to prevent the short circuit current as discussed above. It should be recognized that if NMOS transistors are employed for the pair of diode-connected transistors, then the gates should be connected to the third node N3 (not shown in this Figure). It should be recognized that any of the diode-connected transistors that are disclosed herein as PMOS transistors can be instead implemented as NMOS transistors by changing the connection of the gate from the drain to the source. Similarly, it should be recognized that any of the diode-connected transistors that are disclosed herein as NMOS transistors can be instead implemented as PMOS transistors by changing the connection of the gate from the source to the drain.

The feedback circuits illustrated in FIGS. 4D-4F comprise fifth M5, sixth M6, seventh M7, and eighth M8 transistors, each comprising a source, gate, and drain. The fifth M5 and sixth M6 transistors form a first half cross-coupled rectifier. The seventh M7 and eighth M8 transistors form a second half cross-coupled rectifier. The sources of the fifth M5 and sixth M6 transistors are coupled to the fifth node N5. The sources of the seventh M7 and eighth M8 transistors are coupled to the sixth node N6. In the feedback circuits 400D-400F, the NMOS transistors (i.e., M5 and M7) are low threshold transistors that turn on at lower input power or input voltage to provide the Vss signal at low power or low voltage and the PMOS transistors (i.e., M6 and M8) are high threshold transistors that turn on at high input power or input voltage to provide the Vdd signal at high power or high voltage. The differences between FIGS. 4D-4F are addressed below.

Turning first to FIG. 4D, the gate of the fifth transistor M5 is coupled to a seventh node N7. The gates of the fourth M4 and sixth M6 transistors and the drains of the fifth M5 and sixth M6 transistors are coupled to a ninth node N9. The gate of the seventh transistor M7 is coupled to an eighth node N8. The gates of the second M2 and eighth M8 transistors and the drains of the seventh M7 and eighth M8 transistors are coupled to a tenth node N10.

A seventh capacitor C7 is coupled between the first N1 (not illustrated in this figure) and eighth N8 nodes. An eighth capacitor C8 is coupled between the first N1 and ninth N9 nodes. A ninth capacitor C9 is coupled between the second N2 (not illustrated in this figure) and tenth nodes N10. A tenth capacitor C10 is coupled between the second N2 and seventh N7 nodes.

The feedback circuit 400D also includes a pair of diode-connected transistors D5 and D6 coupled to the second output terminal VSS and the seventh N7 and eighth N8 nodes. In the illustrated embodiment, the pair of diode-connected transistors D5 and D6 are NMOS transistors, each comprising a source, gate, and drain. The sources of the pair of diode-connected transistors D5 and D6 are coupled to the second output terminal VSS. The gate and drain of a first one D5 of the pair of diode-connected transistors are coupled to the seventh node N7. The gate and drain of a second one D6 of the pair of diode-connected transistors are coupled to the eighth node N8. These diode-connected transistors D5 and D6 in the feedback circuit 400D operate similarly to those in feedback circuit 400A to prevent the short circuit current as discussed above. It should be recognized that if PMOS transistors are employed for the pair of diode-connected transistors, then the gates should be connected to the sources.

Referring now to FIG. 4E, the drains of the fifth M5 and sixth M6 transistors and the gate of the first transistor M1 are coupled to a tenth node N10. The gate of the fifth transistor M5 is coupled to the fifth node N5. The gate of the sixth transistor M6 is coupled to a ninth node N9. The drains of the seventh M7 and eighth M8 transistors and the gate of the third transistor M3 are coupled to the seventh node N7. The gate of the seventh transistor M7 is coupled to the sixth node N6. The gate of the eighth transistor M8 is coupled to the eighth node M8.

A third capacitor C1 is coupled between the first N1 and seventh N7 nodes. A fourth capacitor C4 is coupled between the first N1 and eighth N8 nodes. A fifth capacitor C5 is coupled between the second N2 and tenth N10 nodes. A sixth capacitor C6 is coupled between the second N2 and ninth N9 nodes. A pair of diode-connected transistors D1 and D2 are coupled to the first output terminal VDD and the eighth N8 and ninth N9 nodes.

In the illustrated embodiment, the pair of diode-connected transistors D1 and D2 are PMOS transistors, each comprising a source, gate, and drain. The sources of the pair of diode-connected transistors D1 and D2 are coupled to the first output terminal VDD. The gate and drain of a first one D1 of the pair of diode-connected transistors are coupled to the ninth node N9. The gate and drain of a second one D2 of the pair of diode-connected transistors are coupled to the eighth node N8. These diode-connected transistors D1 and D2 in the feedback circuit 400E operate similarly to those in feedback circuit 400A to prevent the short circuit current as discussed above. It should be recognized that if NMOS transistors are employed for the pair of diode-connected transistors, then the gates of D1 and D2 should be connected to the third terminal (VDD terminal).

Turning now to FIG. 4F, which is a feedback circuit FB for the self-biased rectifier circuit 300E of FIG. 3E. The gates of transistor M5 and M6 are coupled to a seventh node N7. The gates of transistor M7 and M8 are coupled to an eighth node N8. The drain of the fifth transistor M5 is coupled to the gate of the third transistor M3. The drain of the sixth transistor M6 is coupled to the gate of the fourth transistor M4. The drain of the seventh M7 transistor is coupled to the gate of the first transistor M1. The drain of the eighth transistor M8 is coupled to the gate of the second transistor M2. A fourth capacitor C4 is coupled between the first N1 and eighth N8 nodes. A sixth capacitor C6 is coupled between the second N2 and seventh N7 nodes. It should be recognized that in the feedback circuit of FIG. 4F, transistors M5 and M7 can be connected to the gates of either of transistors M1 or M3 and that transistors M6 and M8 can be connected to the gates of either of M2 or M4.

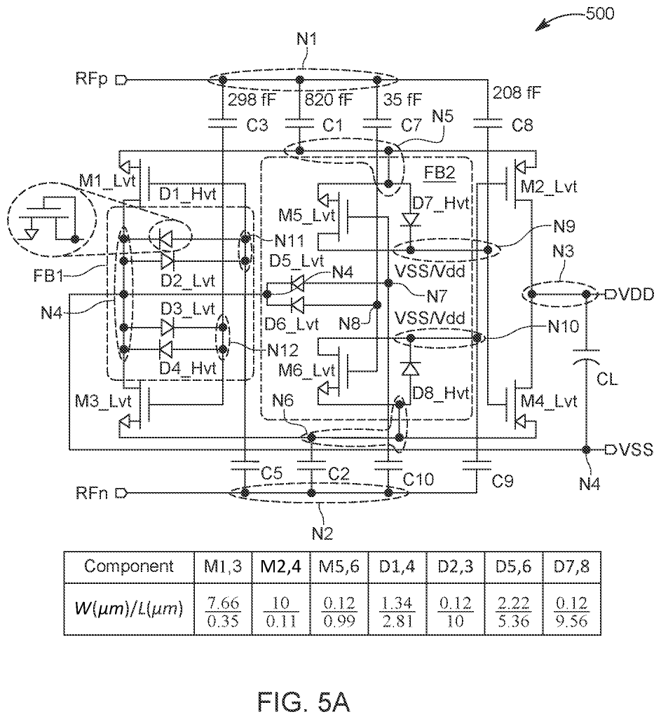

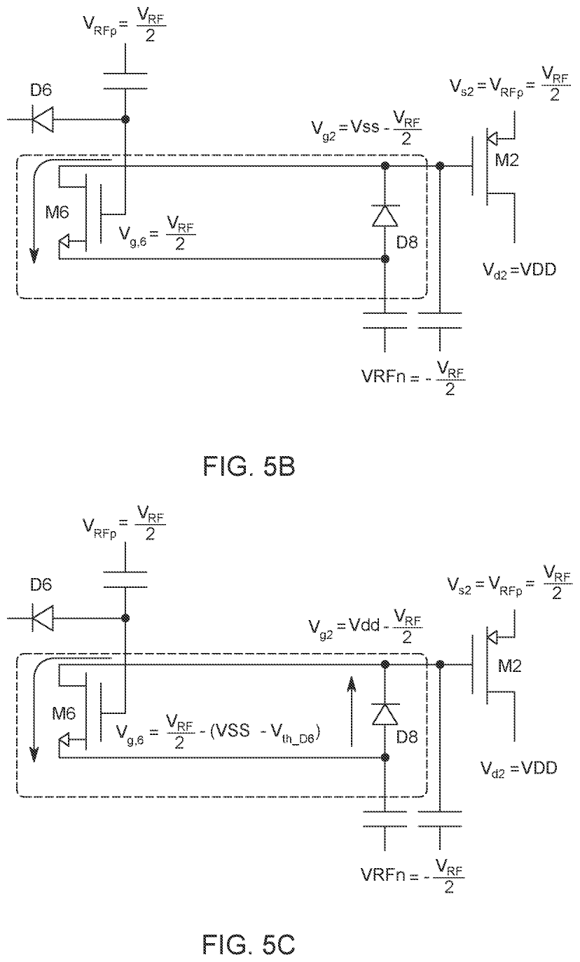

A more detailed explanation of the operation of the self-biased rectifier circuits discussed herein will now be presented in connection with the self-biased rectifier circuit illustrated in FIGS. 5A-5C, which illustrate the components of the feedback circuit as incorporated into the self-biased rectifier. The self-biased rectifier circuit 500 is essentially a combination of the circuit 300D of FIG. 3D with the feedback circuit 400C of FIG. 4D as the feedback circuit FB2. RFₚ and RFₙ in FIG. 5A respectively correspond to the first AC1 and second AC2 input terminals in FIG. 3B.

Turning now to FIG. 5A, the feedback circuit comprises a first FB1 and second FB2 feedback circuit. The first feedback circuit FB1 comprises first D1, second D2, third D3, and fourth D4 diode-connected transistors. The second feedback circuit comprises fifth M5 and sixth M6 transistors and seventh D7 and eighth D8 diode-connected transistors. The fifth M5 and sixth M6 transistors each comprise a source, gate, and drain. The source of the fifth transistor M5 is coupled to the fifth node N5. The drain of the fifth transistor M5 is coupled to a ninth node N9. The gate of the fifth transistor M5 is coupled to a seventh node N7. The source of the sixth transistor M6 is coupled to the sixth node N6. The drain of the sixth transistor M6 is coupled to a tenth node N10. The gate of the sixth transistor M6 is coupled to an eighth node N8. The seventh diode-connected transistor D7 is coupled between the fifth N5 and ninth N9 nodes. The eighth diode-connected transistor D8 is coupled between the sixth N6 and tenth N10 nodes. The first D1 and second D2 diode-connected transistors are coupled between the fourth node N4 and an eleventh node N11. The third D3 and fourth D4 diode-connected transistors are coupled between the fourth node N4 and a twelfth node N12. The gate of the first transistor M1 is coupled to the eleventh node N11. The gate of the second transistor M2 is coupled to the tenth node N10. The gate of the third transistor M3 is coupled to the twelfth node N12. The gate of the fourth transistor M4 is coupled to the ninth node N9.

A third capacitor C3 is coupled between the first N1 and twelfth N12 nodes. A fifth capacitor C5 is coupled between the second N2 and eleventh N11 nodes. A seventh capacitor C7 is coupled between the first N1 and eighth N8 nodes. An eighth capacitor C8 is coupled between the first N1 and ninth N9 nodes. A ninth capacitor C9 is coupled between the second N2 and tenth N10 nodes. A tenth capacitor C10 is coupled between the second N2 and seventh N7 nodes. A pair of diode-connected transistors D5 and D6 are coupled to the fourth N4, seventh N7, and eighth N8 nodes.

In the self-biased rectifier 500 of FIG. 5A, the diode-connected transistors D1 and D4 prevent the reverse current leakage in transistors M1 and M3, respectively, by lowering the biasing voltage at the gate of transistors M1 and M4 and high power or high voltage. The diode-connected transistors D2 and D3 enhance the forward current by assisting the transistors M1 and M3.

As indicated by the bubble extending from transistor D1, this diode, as well as all other diodes in this circuit, are implemented as diode-connected transistors. This is due to the fact CMOS processing does not allow for the formation of a pure diode; nonetheless, the diode-connected transistor performs the same function as a pure diode. In FIG. 5A, the various transistors and transistor-connected diodes are appended with a notation of Lvt indicating it is a low threshold voltage transistor (low voltage being, for example, 270 mV) or Hvt indicating that it is a high threshold voltage transistor (high voltage being, for example, 600 mV for the PMOS transistors and 500 mV for the NMOS transistors). Further, the values of the capacitors on the bottom of the circuit are the same as the values of the corresponding ones on the top of the circuit (i.e., C5=C3; C2=C1; C10=C7, and C9=C8). It should be recognized, however, that these particular capacitance values are merely examples and capacitors with other capacitance values can be employed.

It should be noted that in the circuit of FIG. 5A, unlike the circuit of FIG. 3D in which the first feedback circuit FB1 is coupled to capacitors C3, C4, C5, and C6, the first feedback circuit FB1 in FIG. 5A is coupled only to capacitors C3 and C5 (i.e., the connections via capacitors C4 and C6 are omitted). Further, it should be noted that diode-connected transistors D2 and D3 support the conduction of transistors M1 and M3, a feature that is not present in the other disclosed feedback circuits.

As illustrated in FIG. 5A, the self-biased rectifier circuit 500 includes four low-threshold (V_{th_L}) rectifying transistors M1-M4, a feedback circuit FB that includes two identical nested rectifying circuits connected to the gates of transistors M2 and M4, six diode-connected transistors D1-D6, and eight coupling capacitors C1-C8.

Weak-conduction low-threshold voltage transistors M5 and M6 are respectively connected in parallel with a high-threshold (V_{th_H}) diode D7 and D8. The weak conduction of transistors M5, M6, D7, and D8 is achieved using transistors with a small width to length ratio (W/L) to reduce the current flow. In such a configuration, transistors M5 and M6 respectively produce a Vss dc signal at the gate of transistors M2 and M4 at low input power or low input voltage, while transistors D7 and D8 respectively produce a Vdd dc voltage signal at high input power or high input voltage. The feedback circuit FB acts as a special type of a rectifier where the positive terminal (the cathode of transistors D7 and D8) and the negative terminal (the drains of transistors M5 and M6) are shorted together and are respectively coupled to the gates of transistors M2 and M4. Because transistors D7 and D8 are high-threshold diodes, their operation is limited to relatively high input power level (i.e., when the instantaneous RF voltage becomes larger than V_{th_H}). On the other hand, the low threshold voltage of transistors M5 and M6 result in a pronounced operation at low input power or low input voltage. For such a configuration, the feedback circuit FB is able to generate a Vss dc voltage at low input power and a Vdd voltage at high input power.

Transistors D5 and D6 are respectively coupled to the gates of transistors M5 and M6 in order to reduce the short-circuit current between transistors D7 and M5 and between transistors D8 and M6 at high input power or high input voltage (i.e., when both M5,6 and D7,8 are ON). Transistors D5 and D6 act as switches to respectively reduce the conduction of transistors M5 and M6 by lowering the dc voltage at the gate of transistors M5 and M6 at high power or high input voltage levels. Thus, at low input power (or low input voltage), the voltage-drop across transistors D5 and D6 is relatively low (less than the threshold voltage of the diode-connected transistor), and accordingly the diode-connected transistor remains OFF and acts as an open-circuit. However, at relatively high input power (equivalently high input voltage), the voltage-drop across transistors D5 and D6 exceeds the threshold voltage of the diode-connected transistors, and accordingly the diode-connected transistors are ON and the diode-connected transistors drain current from the gates of transistors M5 and M6, respectively. This lowers the dc voltage at the gate of transistors M5 and M6. Transistors D5 and D6 are weak-conduction diodes in order to reduce the leakage dc current from the feedback circuit FB to the load (i.e., VSS terminal). Similarly, the high-threshold transistors D1 and D2 are respectively coupled to the gates of transistors M1 and M3, which lowers the dc voltage at the gate, and accordingly reducing I_{REV} in transistors M1 and M3 at high input power. On the other hand, transistors D2 and D4 respectively enhance the I_{FWD} of transistors M1 and M3 by draining more current from the negative terminal of the load (VSS).

FIGS. 5B and 5C illustrate the steady-state operating points of transistor M2 (transistor M4 has similar operating points). At low input power, transistor M6 is ON and transistor D8 is OFF. Accordingly, the driving voltage (V_{SG}) of transistor M2 is:

V_{SG_low power_M2,4}=V_{RF}−V_{SS} (1)

where V_{RF} is the instantaneous RF voltage and VSS is the negative dc voltage supplied by the feedback circuit FB. This high driving voltage is important at low input power where I_{REV} is negligible and the need to enhance I_{FWD} is critical. On the other hand, as illustrated in FIG. 5C, at high input power, transistor D8 is ON and transistor M6 is OFF. For such case, the driving voltage (V_{SG}) of M2 is:

V_{SG_high power_M2,4}=V_{RF}−Vdd≈V_{RF}−V_{dd} (2)

where Vdd is the positive dc voltage supplied by the feedback circuit FB. This small driving voltage is essential at high input power where reducing I_{REV} is critical.

The driving voltages of the different self-biased based architectures were examined, including the self-biased rectifier circuit of FIG. 5A, the FX circuit of FIG. 2A, the self-biased circuit of FIG. 2B, and a double-sided diode circuit (such as the one disclosed in Reference [1]). This examination revealed that the self-biased rectifier circuit of FIG. 5A was the only architecture with a high driving voltage at low input power allowing for high I_{FWD}. The self-biased rectifier circuit of FIG. 5A also maintains the enhanced performance at high input power levels by reducing I_{REV}.

The performance of different types of rectifiers (including the self-biased rectifier circuit of FIG. 5A, the FX rectifier of FIG. 2A, a half-wave rectifier, and a full wave rectifier) was simulated in 65 nm CMOS technology, 433 MHz frequency and with a 100 kΩ load. The simulation results indicate that the self-biased rectifier circuit of FIG. 5A has a significantly lower effective threshold voltage of about 170 mV, compared to the other architectures. The reduction of the effective threshold voltage of the self-biased rectifier circuit of FIG. 5A below the actual threshold voltage (i.e., about 270 mV for a low threshold NMOS transistor in 65 nm technology, as anticipated from the performance of the half bridge rectifier) is due to the subthreshold conduction (I_{subthreshold}) of transistor M5 and M6, which is described by:

$$\begin{matrix}{I}_{subthreshold} = {I}_{ds 0} {e}^{\frac{{V}_{gs} - {V}_{th}}{{nv}_{T}}} ( 1 - {e}^{\frac{- {V}_{ds}}{{v}_{T}}} ) \\ = {I}_{ds 0} {e}^{\frac{{V}_{RF} - {V}_{th}}{{nv}_{T}}} ( 1 - {e}^{\frac{0.5 {V}_{RF} - {V}_{g , M 2 , 4}}{{v}_{T}}} )\end{matrix} \qquad ( 3 )$$

where n and I_{ds0} are process dependent parameters, V_{T} is the thermal voltage, V_{g,M2,4} is the dc voltage at the gates of transistors M2 and M4, and Vₜₕ in the threshold voltage of transistors M5 and M6. I_{subthreshold} results in the charging the equivalent capacitance at the gates of transistors M2 and M4, and accordingly changes the dc operating points of transistors M2 and M4 even when the RF voltage is below the threshold voltage. For such case, the dc voltage at the gates of transistors M2 and M4 is equal to:

$${V}_{sub} = \frac{1}{{C}_{total}} \int {I}_{subthreshold} dt \qquad ( 4 )$$

where Cₜₒₜₐₗ is the total equivalent capacitance seen at the node connected the gate of transistors M2 and M4, and approximated as:

Cₜₒₜₐₗ≈C_{g,M2,4}//C_{D7,8}//C_{coupling} (5)

where C_{g,M2,4} is the gate capacitance of transistors M2 and M4, and C_{D7,8} is the equivalent capacitance looking at the cathode of transistors D7 and D8. As a consequence, the effective threshold voltage of the rectifier is lowered by V_{sub}, and it equals:

V_{th_eff}=|Vₜₕ|−|V_{dc}_{_{g}}_{,M2,4}|Vₜₕ|−|V_{sub}| (6)

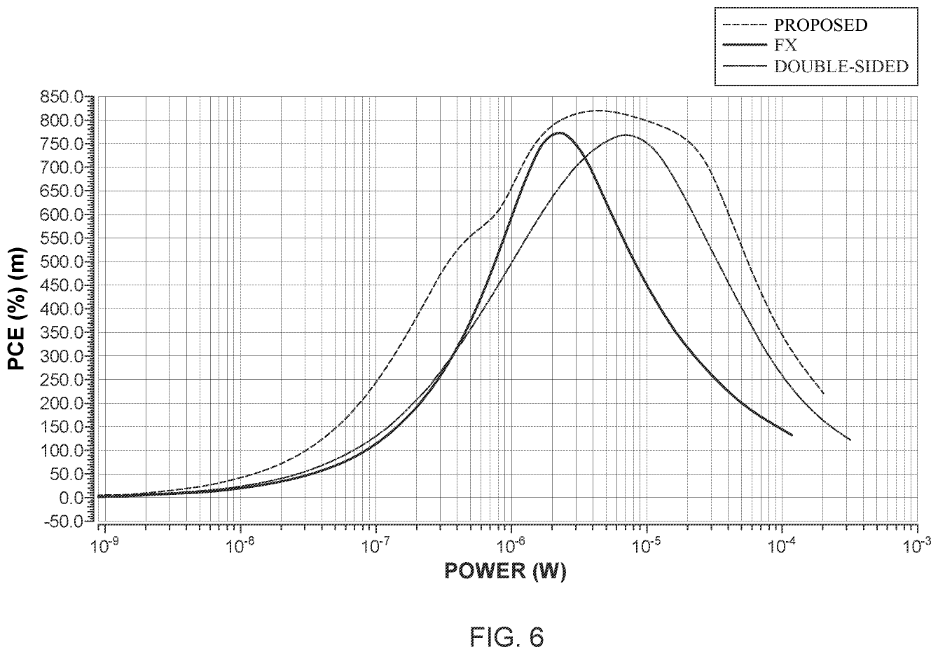

This reduction in the effective threshold voltage is reflected in the overall performance of the rectifier at low input power, as illustrated in FIG. 6, which illustrates a comparison of the power conversion efficiency of the self-biased rectifier circuit of FIG. 5A, the FX rectifier of FIG. 2A, and the double-side architecture discussed in Reference [1] all operating with a high frequency signal. As illustrated, due to the ability of the feedback circuit FB to supply either Vdd or Vss depending upon the magnitude of the input power or the input voltage, the self-biased rectifier circuit of FIG. 5A achieves consistently efficient performance across an extended range of the input power, resulting in higher output voltage and power conversion efficiency at low- and high-input power levels compared to the other architectures. Simulation results revealed more than 100% enhancement of the power conversion efficiency compared to the FX rectifier when the input power is less than −30 dBm.

In order to further validate the self-biased rectifier circuit of FIG. 5A, this circuit and an FX rectifier were fabricated and subject to evaluation. The self-biased rectifier circuit of FIG. 5A was implemented in 65 nm standard CMOS technology. In order to provide a fair comparison, the FX rectifier was also fabricated on the same die. The rectifying transistors M1-M4 for both architectures were low-threshold transistors. The FX rectifier was optimized separately for its optimum performance (FX sizing: transistors M1 and M3=1480 μm/180 nm and transistors M2 and M4=4 μm/100 nm). The self-biased rectifier circuit of FIG. 5A occupied an area of 6.48×10 3 μm², compared to 0.43×10 3 μm² for the FX rectifier. This increase in the area for the self-biased rectifier circuit of FIG. 5A is mostly due to the extra coupling capacitors introduced in the self-biased rectifier circuit of FIG. 5A.

The measurement setup involved a vector network analyzer (VNA) (Agilent N5225A), a digital multimeter (Keysight 34420A), and a 100 kΩ load. The test was achieved by RF probing the chip using a GSGSG differential probe with a reference plane set to the on-chip pads of the rectifier's input. After that, the RF power of the VNA was swept, and the corresponding S-parameters and the output voltage at the load were recorded. The instantaneous input power delivered to the rectifier was calculated by de-embedding the transmission and the reflection losses, as described by the following equation:

Pᵢₙ=P_{source}(dBM)−L_{cable}(dB)−10log|S_{11rect}|² (7)

where P_{source} is the output RF power supplied by the VNA, L_{cable} is the losses of the RF cable, and S_{11rect} is the measured S-parameters of the rectifier's input. Finally, the power conversion efficiency of the rectifiers was calculated as follow:

$$PCE = \frac{{P}_{out}}{{P}_{in}} \frac{{v}_{out}^{2} \text{/} {R}_{Load}}{{P}_{in}} \qquad ( 8 )$$

where Pₒᵤₜ is the output power delivered to the load, vₒᵤₜ is the output voltage, and R_{LOAD} is the 100 kΩ load.

The testing revealed that the self-biased rectifier circuit of FIG. 5A generally offers an enhanced performance across the full range of the input power with a peak power conversion efficiency of 86%, compared to 72% for the FX rectifier. The enhanced performance at low input power (i.e., input power less than −30 dBm) is exclusive for the self-biased rectifier circuit of FIG. 5A and is not present in the FX rectifier. For example, at −35 dBm input power, the power conversion efficiency of the self-biased rectifier circuit of FIG. 5A rectifier was 38% which is more than two times the efficiency of the FX rectifier. The superb performance at both the low and the high input power is reflected in the extended dynamic range of the self-biased rectifier circuit of FIG. 5A. The dynamic range is defined as the range where the performance of the rectifier exceeds 80% of the peak power conversion efficiency. The dynamic range is influenced by both the low and the high power performance of the rectifier and is calculated by:

DR(dB)=Pₘₐₓ(dBm)−Pₘᵢₙ(dBm) (9)

where Pₘₐₓ and Pₘᵢₙ are the range where the power conversion efficiency ≥0.8×peak power conversion efficiency. A comparison of the peak power conversion efficiency and dynamic range of the self-biased rectifier circuit of FIG. 5A and the FX rectifier for different loads revealed that the self-biased rectifier circuit of FIG. 5A consistently offered improved performance compared to the FX rectifier, with up to 19% enhancement in the peak power conversion efficiency and 53% in the dynamic range.

Evaluation of the measured output dc versus the input power showed that the self-biased rectifier circuit of FIG. 5A offered a boosted output voltage across the full range of the input power. This improvement in the output voltage is reflected in the sensitivity of the rectifier defined as the input power required to generate a 1-V output voltage at the load. The sensitivity of the self-biased rectifier circuit of FIG. 5A was −19.2 dBm, which is more than 13 dB better than the FX rectifier. Evaluation of the measured output voltage for different loads (ranging from 30 kΩ to 100 kΩ) and input power levels (ranging from −35 dBm to −15 dBm) revealed that the self-biased rectifier circuit of FIG. 5A maintained the enhanced performance for the large range of the input power and the resistive loads.

The self-biased rectifier circuit of FIG. 5A was compared with the state-of-the-art rectifiers designed in CMOS technology and operating at similar frequency range. This comparison revealed that the self-biased rectifier circuit of FIG. 5A offers the best sensitivity, peak power conversion efficiency, and dynamic range. Moreover, the self-biased rectifier circuit of FIG. 5A offers the best low-power performance with a power conversion efficiency of 57% at −30 dBm. The double-sided architecture of Reference [1] offers a similar peak power conversion efficiency and sensitivity, yet, the self-biased rectifier circuit of FIG. 5A offers 3.4 dB wider DR and 37% higher power conversion efficiency at −30 dBm input power due to the superb low power performance of the proposed architecture. A circuit with adaptive threshold voltage compensation (disclosed in Reference [2]) offers a similar dynamic similar dynamic range to the self-biased rectifier circuit of FIG. 5A, yet, the self-biased rectifier circuit of FIG. 5A offers more than double the peak power conversion efficiency.

As will be appreciated from the discussion above, the self-biased rectifier circuit of FIG. 5A enhances the low- and high-power performance of the fully cross-coupled architecture by dynamically changing the dc operating points of the rectifying transistors. At low input power or low input voltage, it applies a Vss dc voltage at the gates of the PMOS rectifying transistors to enhance their conductivity. On the other hand, the reverse leakage current at high input power (or equivalently high input voltage) is reduced by applying a Vdd dc voltage at the gates of the PMOS rectifying transistors. Although an example was described in which the self-biased rectifier circuit of FIG. 5A was implemented in 65 nm CMOS technology using low- and high-threshold transistors, the rectifier circuit is scalable to other technologies. The self-biased rectifier circuit of FIG. 5A is particularly advantageous by providing a high peak power conversion efficiency of 86% with exceptionally low-power performance exceeding 10% for input power greater than −40 dBm.

Although detailed testing and evaluation was only performed with respect to the self-biased rectifier circuit of FIG. 5A, similar performance can be achieved with the self-biased rectifier circuits of FIGS. 3A-3D using the feedback circuits of FIGS. 4A-4E, i.e., high peak power conversion efficiency and exceptional low-power performance. Further, the self-biased rectifier circuit of FIG. 3E should exhibit a high peak power conversion efficiency and exceptional high-power performance (the circuit of FIG. 3E is configured only to enhance the high-power performance).

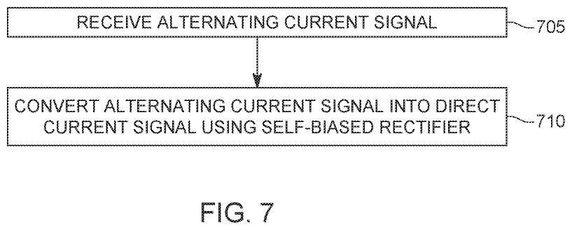

Although a description of the self-biased rectifiers has been provided in connection with the description of the structures of these circuits, the method of operation will now be described in connection with the flowchart of FIG. 7. A self-biased rectifier circuit, which includes first AC1 and second AC2 input terminals and first VDD and second VSS output terminals, receives an alternating current signal (step 705). The self-biased rectifier circuit converts the alternating current signal into a direct current signal (step 710). The self-biased rectifier circuit includes first M1, second M2, third M3, and fourth transistors M4 arranged as fully cross-coupled rectifier. The conversion of the alternating current signal into a direct current signal involves
providing, by a feedback circuit FB coupled to the gates of the first M1 and third M3 transistors, a voltage obtained from the first AC1 and second AC2 input terminals to the gates of the first M1 and third M3 transistors depending upon a magnitude of power or the voltage applied to the first AC1 and second AC2 input terminals; and/or providing, by the feedback circuit FB coupled to the gates of the second M2 and fourth M4 transistors, a voltage obtained the first AC1 and second AC2 input terminals to the gates of the second M2 and fourth M4 transistors depending upon a magnitude of power (or the voltage) applied to the first AC1 and second AC2 input terminals.

With respect to the self-biased rectifier circuit of FIG. 3A, the operation of this circuit will depend upon whether one or both of the first FB1 and second FB2 feedback circuits are implemented. If only the first feedback circuit FB1 is implemented, the circuit of FIG. 3A will operate similarly to the circuit of FIG. 3C, which is described in more detail below. If only the second feedback circuit FB2 is implemented, the circuit of FIG. 3A will operate similarly to the circuit of FIG. 3B, which is described in more detail below. If both the first FB1 and second FB2 feedback circuits are implemented, the circuit of FIG. 3A will operate similarly to the circuit of FIG. 3D, which is described in more detail below.

With respect to the self-biased rectifier circuit of FIG. 3B, the feedback circuit FB is coupled to the gates of the first M2 and third M4 transistors. The feedback circuit FB provides the voltage Vss to the gates of the second M2 and fourth M4 transistors when the magnitude of the power of the received alternating current signal is less than or equal to a first power level (or equivalently, when the magnitude of the voltage of the received alternating current signal is less than or equal to a first voltage level), and the feedback circuit FB provides the voltage Vdd to the gates of the second M2 and fourth M4 transistors when the magnitude of the power of the received alternating current signal is greater than or equal to the first power level (or equivalently, when the magnitude of the voltage of the received alternating current signal is greater than or equal to a first voltage level).

With respect to the self-biased rectifier circuit of FIG. 3C, the feedback circuit FB is coupled to the gates of the first M1 and third M3 transistors. The feedback circuit FB provides the Vdd voltage to the gates of the first M1 and third M3 transistors when the magnitude of the power (or the voltage) of the received alternating current signal is less than or equal to a first power level and the feedback circuit FB provides the Vss voltage to the gates of the first M1 and third M3 transistors when the magnitude of the power of the received alternating current signal is greater than or equal to the first power level.

With respect to the self-biased rectifier circuit of FIG. 3D, the feedback circuit FB comprises a first FB1 and second FB2 feedback circuit. The first feedback circuit FB1 is coupled to the gates of the first M1 and third M3 transistors. The first feedback circuit FB1 provides the Vdd voltage obtained from input terminals AC1 and AC2 to the gates of the first M1 and third M3 transistors when the magnitude of the power (or the voltage) of the received alternating current signal is less than or equal to a first power or voltage level, and the first feedback circuit FB1 provides the Vss voltage to the gates of the first M1 and third M3 transistors when the magnitude of the power (or voltage) of the received alternating current signal is greater than or equal to the first power (or voltage) level. The second feedback circuit FB2 is coupled to the gates of the second M2 and fourth M4 transistors. The second feedback circuit FB2 provides the Vss voltage to the gates of the second M2 and fourth M4 transistors when the magnitude of the power or voltage of the received alternating current signal is less than or equal to the first power or voltage level and the second feedback circuit FB2 provides the Vdd voltage to the gates of the second M2 and fourth M4 transistors when the magnitude of the power or voltage of the received alternating current signal is greater than or equal to the first power or voltage level.

With respect to the self-biased rectifier circuit of FIG. 3E, the feedback circuit FB is coupled to the gates of the first M1, second M2, third M3, and fourth M4 transistors. The feedback circuit FB provides a Vdd voltage to the gates of the second M2 and fourth M4 transistors when the magnitude of the power of the received alternating current signal is greater than or equal to a first power or voltage level, and the feedback circuit FB provides a Vss voltage to the gates of the first M1 and third M3 transistors when the magnitude of the power or voltage of the received alternating current signal is greater than or equal to the first power level or voltage level, respectively.

Although the discussion above focusses on the structure of the self-biased rectifier and feedback circuits, it should be recognized that this disclosure also covers methods of making these circuits by coupling the various circuit elements to each other in the manner discussed above.

The disclosed embodiments provide self-biased rectifier circuits that can be used to convert received radio frequency power or voltage into direct current power in a wireless power receiver. It should be understood that this description is not intended to limit the invention and that the self-biased rectifier circuits can be used in other applications. For example, the self-biased rectifier circuits can be used in radio frequency identification (RFID) systems, wireless sensors, radio frequency energy harvesting/scavenging systems, wireless powering systems, wireless charging systems, wireless charging of electric vehicles, wireless charging of consumer electronic, power detectors, etc. Thus, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

References:

[1] A. S. Almansouri, M. H. Ouda, and K. N. Salama, “A CMOS RF-to-DC Power Converter With 86% Efficiency and—19.2-dBm Sensitivity,” IEEE Transactions on Microwave Theory and Techniques, vol. 66, no. 5, pp. 2409-2415, 2018.

[2] Y.-S. Luo and S.-I. Liu, “A Voltage Multiplier With Adaptive Threshold Voltage Compensation,” IEEE Journal of Solid-State Circuits, vol. 52, no. 8, pp. 2208-2214, 2017.

1. A self-biased rectifier circuit, comprising:
first and second input terminals;
first and second output terminals;
a rectifier comprising first, second, third, and fourth transistors, each comprising a source, gate, and drain, wherein the sources of the first and second transistors and the gates of the third and fourth transistors are coupled to the first input terminal, the sources of the third and fourth transistors and the gates of the first and second transistors are coupled to the second input terminal, the drains of the first and third transistors are coupled to the second output terminal, and the drains of the second and fourth transistors are coupled to the first output terminal; and
a feedback circuit (FB) comprising a plurality of transistors configured as at least one rectifier, wherein
the feedback circuit (FB) is coupled to the gates of the first and third transistors and the plurality of transistors are configured to provide a first biasing voltage or a second biasing voltage to the gates of the first and third transistors depending upon a magnitude of power or voltage applied to the first and second input terminals; and/or
the feedback circuit (FB) is coupled to the gates of the second and fourth transistors and the plurality of transistors are configured to provide a first biasing voltage or a second biasing voltage to the gates of the second and fourth transistors depending upon a magnitude of power or voltage applied to the first and second input terminals.

2. The self-biased rectifier circuit of claim 1, wherein
the first input terminal is coupled to a first node,
the second input terminal is coupled to a second node,
the first output terminal and the drains of the second and fourth transistors are coupled to a third node,
the second output terminal and the drains of the first and third transistors are coupled to a fourth node,
the sources of the first and second transistors and the feedback circuit are coupled to a fifth node,
a first capacitor is coupled between the fifth node and the first node,
the sources of the third and fourth transistors and the feedback circuit are coupled to a sixth node, and
a second capacitor is coupled between the sixth node and the second node.

3. The self-biased rectifier circuit of claim 2, wherein the feedback circuit comprises one or more feedback circuits, and wherein
one of the one or more feedback circuits is coupled to the gates of the second and fourth transistors and the self-biased rectifier circuit further comprising an eighth capacitor coupled between the first node and the gate of the fourth transistor and a ninth capacitor coupled between the second node and the gate of the second transistor, and/or
a second one of the one or more feedback circuits is coupled the gates of the first and third transistors and the self-biased rectifier circuit further comprising a third capacitor coupled between the first node and the gate of the third transistor and a fifth capacitor coupled between the second node and the gate of the first transistor.

4. The self-biased rectifier circuit of claim 2, wherein the feedback circuit is coupled to the gates of the second and fourth transistors and to the fourth node, the self-biased rectifier circuit further comprising:
an eighth capacitor coupled between the first node and the gate of the fourth transistor;
a seventh capacitor coupled between the feedback circuit and the first node;
a ninth capacitor coupled between the second node and the gate of the second transistor; and
a tenth capacitor coupled between the second node and the feedback circuit.

5. The self-biased rectifier circuit of claim 2, wherein the feedback circuit is coupled to the gates of the first and third transistors and to the third node, the self-biased rectifier circuit further comprising:
a third capacitor coupled between the first node and the gate of the third transistor;
a fourth capacitor coupled between the first node and the feedback circuit;
a fifth capacitor coupled between the second node and the gate of the first transistor; and
a sixth capacitor coupled between the second node and the feedback circuit.

6. The self-biased rectifier circuit of claim 2, wherein the feedback circuit comprises a first and second feedback circuit, the first feedback circuit is coupled to the gates of the first and third transistors and to the third node, and the second feedback circuit is coupled to the gates of the second and fourth transistors and to the fourth node, the self-biased rectifier circuit further comprising:
a third capacitor coupled between the first node and the gate of the third transistor;
a fourth capacitor coupled between the first node and the first feedback circuit;
a fifth capacitor coupled between the second node and the gate of the first transistor;
a sixth capacitor coupled between the second node and the first feedback circuit;
a seventh capacitor coupled between the first node and the second feedback circuit;
an eighth capacitor coupled between the first node and the gate of the fourth transistor;
a ninth capacitor coupled between the second node and the gate of the second transistor; and
a tenth capacitor coupled between the second node and the second feedback circuit.

7. The self-biased rectifier circuit of claim 2, wherein the feedback circuit is coupled to the gates of the first, second, third, and fourth transistors, the self-biased rectifier circuit further comprising:
a third capacitor coupled between the first node and the gate of the third transistor;
a fourth capacitor coupled between the first node and the feedback circuit;
a fifth capacitor coupled between the second node and the gate of the first transistor;
a sixth capacitor coupled between the second node and the feedback circuit;
a ninth capacitor coupled between the second node and the gate of the second transistor; and
an eighth capacitor coupled between the first node and the gate of the fourth transistor.

8. The self-biased rectifier circuit of claim 2, wherein the plurality of transistors of the feedback circuit comprise fifth, sixth, seventh, eighth, ninth, tenth, eleventh, and twelfth transistors, each comprising a source, gate, and drain, wherein the fifth, sixth, seventh, and eighth transistors form a first fully cross-coupled rectifier, wherein the ninth, tenth, eleventh, and twelfth transistors form a second fully cross-coupled rectifier, wherein the sources of the fifth, sixth, ninth, and tenth transistors are coupled to the fifth node, and wherein the sources of the seventh, eighth, eleventh, and twelfth transistors are coupled to the sixth node.

9. The self-biased rectifier circuit of claim 8, wherein
the gates of the fifth, sixth, ninth, and tenth transistors are coupled to an eighth node,
the gates of the seventh, eighth, eleventh, and twelfth transistors are coupled to a ninth node,
the drains of the fifth, sixth, seventh, and eighth transistors and the gate of the fourth transistor are coupled to a tenth node,
the drains of the ninth, tenth, eleventh, and twelfth transistors and the gate of the second transistor are coupled to a seventh node, and
an eighth capacitor is coupled between the first and tenth nodes,
a seventh capacitor is coupled between the first and ninth nodes,
a ninth capacitor is coupled between the second and seventh nodes,
a tenth capacitor is coupled between the second and eighth nodes, and
a pair of diode-connected transistors are coupled to the second output terminal and the eighth and ninth nodes.

10. The self-biased rectifier circuit of claim 8, wherein
the gates of the fifth and ninth transistors are coupled to an eighth node,
the gates of the seventh and eleventh transistors are coupled to a ninth node,
the drains of the fifth, sixth, seventh, and eighth transistors, the gates of the sixth and eighth transistors, and the gate of the fourth transistor are coupled to a tenth node,
the drains of the ninth, tenth, eleventh, and twelfth transistors, the gates of the tenth and twelfth transistor, and the gate of the second transistor are coupled to a seventh node, and
the sources of the seventh, eighth, eleventh, and twelfth transistors are coupled to a twelfth node,
an eighth capacitor is coupled between the first and tenth nodes,
a seventh capacitor is coupled between the first and ninth nodes,
a ninth capacitor is coupled between the second and seventh nodes,
a tenth capacitor is coupled between the second and eighth nodes, and
a pair of diode-connected transistors are coupled to the second output terminal and the eighth and ninth nodes.

11. The self-biased rectifier circuit of claim 8, wherein
the gates of the fifth and ninth transistors are coupled to the fifth node,
the gates of the seventh and eleventh transistors are coupled to the sixth node,
the gates of the eighth and twelfth transistors are coupled to an eighth node,
the gates of the sixth and tenth transistors are coupled a ninth node,
the drains of the fifth, sixth, seventh, and eighth transistors, and the gate of the first transistor are coupled to a tenth node,
the drains of the ninth, tenth, eleventh and twelfth transistors, and the gate of the third transistor are coupled to a seventh node,
a third capacitor is coupled between the first and seventh nodes,
a fourth capacitor is coupled between the first and eighth nodes,
a fifth capacitor is coupled between the second and tenth nodes,
a sixth capacitor is coupled between the second and ninth nodes,
a pair of diode-connected transistors are coupled to the first output terminal and the eighth and ninth nodes.

12. The self-biased rectifier circuit of claim 2, wherein the plurality of transistors of the feedback circuit comprise fifth, sixth, seventh, and eighth transistors, each comprising a source, gate, and drain, wherein the fifth and sixth transistors form a first half cross-coupled rectifier, wherein the seventh and eighth transistors form a second half cross-coupled rectifier, wherein the sources of the fifth and sixth transistors are coupled to the fifth node, and wherein the sources of the seventh and eighth transistors are coupled to the sixth node.

13. The self-biased rectifier circuit of claim 12, wherein
the gate of the fifth transistor is coupled to a seventh node,
the gates of the fourth and sixth transistors and the drains of the fifth and sixth transistor are coupled to a ninth node,
the gate of seventh transistor is coupled to an eighth node,
the gates of the second and eighth transistors and the drains of the seventh and eighth transistors are coupled to a tenth node,
a seventh capacitor is coupled between the first and eighth nodes,
an eighth capacitor is coupled between the first and ninth nodes,
a ninth capacitor is coupled between the second and tenth nodes,
a tenth capacitor is coupled between the second and seventh nodes, and
a pair of diode-connected transistors are coupled to the second output terminal and the seventh and eighth nodes.

14. The self-biased rectifier circuit of claim 12, wherein
the drains of the fifth and sixth transistors, and the gate of the first transistor are coupled to a tenth node,
the gate of the fifth transistor is coupled to the fifth node,
the gate of the sixth transistor is coupled to a ninth node,
the drains of the seventh and eighth transistors, and the gate of the third transistor are coupled to a seventh node,
the gate of the seventh transistor is coupled to the sixth node,
the gate of the eighth transistor is coupled to an eighth node,
a third capacitor is coupled between the first and seventh nodes,
a fourth capacitor is coupled between the first and eighth nodes,
a fifth capacitor is coupled between the second and tenth nodes,
a sixth capacitor is coupled between the second and ninth nodes, and
a pair of diode-connected transistors are coupled to the first output terminal and the eighth and ninth nodes.

15. The self-biased rectifier circuit of claim 12, wherein
the gates of the fifth and sixth transistors are coupled to a seventh node,
the gates of the seventh and eighth transistors are coupled to an eighth node,
the drain of the fifth transistor is coupled to the gate of the third transistor,
the drain of the sixth transistor is coupled to the gate of the fourth transistor,
the drain of the seventh transistor is coupled to the gate of the first transistor,
the drain of the eighth transistor is coupled to the gate of the second transistor,
a fourth capacitor is coupled between the first and eighth nodes, and
a sixth capacitor is coupled between the second and seventh nodes.

16. The self-biased rectifier circuit of claim 2, wherein
the feedback circuit comprises a first and second feedback circuits,
the first feedback circuit comprises first, second, third, and fourth diode-connected transistors,
the second feedback circuit comprises fifth and sixth transistors and seventh and eighth diode-connected transistors, the fifth and sixth transistors each comprise a source, gate, and drain,
the source of the fifth transistor is coupled to the fifth node, the drain of the fifth transistor is coupled to a ninth node, and the gate of the fifth transistor is coupled to a seventh node,
the source of the sixth transistor is coupled to the sixth node, the drain of the sixth transistor is coupled to a tenth node, and the gate of the sixth transistor is coupled to an eighth node,
the seventh diode-connected transistor is coupled between the fifth and ninth nodes,
the eighth diode-connected transistor is coupled between the sixth and tenth nodes,
the first and second diode-connected transistors are coupled between the fourth node and an eleventh node,
the third and fourth diode-connected transistors are coupled between the fourth node and a twelfth node,
the gate of the first transistor is coupled to the eleventh node,
the gate of the second transistor is coupled to the tenth node,
the gate of the third transistor is coupled to the twelfth node,
the gate of the fourth transistor is coupled to the ninth node,
a third capacitor is coupled between the first and twelfth nodes,
a fifth capacitor is coupled between the second and eleventh nodes,
a seventh capacitor is coupled between the first and eighth nodes,
an eighth capacitor is coupled between the first and ninth nodes,
a ninth capacitor is coupled between the second and tenth nodes,
a tenth capacitor is coupled between the second and seventh nodes, and
a pair of diode-connected transistors are coupled to the fourth, seventh, and eighth nodes.

17. A method for converting an alternating current signal into a direct current signal, the method comprising:
receiving the alternating current signal by a self-biased rectifier circuit that includes first and second input terminals and first and second output terminals;
converting, by the self-biased rectifier circuit, the alternating current signal into a direct current signal, wherein the self-biased rectifier circuit includes first, second, third, and fourth transistors arranged as fully cross-coupled rectifier, wherein the conversion of the alternating current signal into a direct current signal comprises
providing, by a feedback circuit (FB) coupled to the gates of the first and third transistors, a voltage obtained from the first and the second input terminals to the gates of the first and third transistors depending upon a magnitude of power or voltage applied to the first and second input terminals; and/or
providing, by a feedback circuit (FB) coupled to the gates of the second and fourth transistors, a voltage obtained from the first and the second input terminals to the gates of the second and fourth transistors depending upon a magnitude of power or voltage applied to the first and second input terminals.

18. The method of claim 17, wherein the feedback circuit is coupled to the gates of the first and third transistors, the feedback circuit provides a high voltage to the gates of the first and third transistors when the magnitude of the power or voltage of the received alternating current signal is less than or equal to a first power or voltage level, and the feedback circuit provides a low voltage to the gates of the first and third transistors when the magnitude of the power or voltage of the received alternating current signal is greater than or equal to a second power or voltage level, wherein the second power level greater than the first power level.

19. The method of claim 17, wherein the feedback circuit is coupled to the gates of the second and fourth transistors, the feedback circuit provides a low voltage to the gates of the second and fourth transistors when the magnitude of the power or voltage of the received alternating current signal is less than or equal to a first power or voltage level and the feedback circuit provides a high voltage to the gates of the second and fourth transistors when the magnitude of the power or voltage of the received alternating current signal is greater than or equal to a second power or voltage level, wherein the second power level greater than the first power level.

20. A wireless power receiver, comprising:
an antenna configured to receive a wireless alternating current signal;
an impedance matching network coupled to the antenna to receive the alternating current signal; and
a self-biased rectifier circuit coupled to the impedance matching network and configured to convert the alternating current signal into a direct current signal, the self-biased rectifier circuit comprising
first and second input terminals coupled to the impedance matching network;
first and second output terminals;
a rectifier comprising first, second, third, and fourth transistors, each comprising a source, gate, and drain, wherein the sources of the first and second transistors and the gates of the third and fourth transistors are coupled to the first input terminal, the sources of the third and fourth transistors and the gates of the first and second transistors are coupled to the second input terminal, the drains of the first and third transistors are coupled to the second output terminal, and the drains of the second and fourth transistors are coupled to the first output terminal; and
a feedback circuit (FB) comprising a plurality of transistors configured as at least one rectifier, wherein
the feedback circuit (FB) is coupled to the gates of the first and third transistors and the plurality of transistors are configured to provide a first biasing voltage or a second biasing voltage to the gates of the first and third transistors depending upon a magnitude of power or voltage applied to the first and second input terminals; and/or
the feedback circuit (FB) is coupled to the gates of the second and fourth transistors and the plurality of transistors are configured to provide a first biasing voltage or a second biasing voltage to the gates of the second and fourth transistors depending upon a magnitude of power or voltage applied to the first and second input terminals.
